(19) United States
(12) Patent Application Publication
(10) Pub. No.: US 2005/0163113 A1
(43) Pub. Date: Jul. 28, 2005

(54) Signaling point code sharing in exchanges

(76) Inventors: Manfred Angermayr, Schrobenhausen (DE); Walter Held, Geretsried (DE); Helmut Richter, Freising (DE)

Correspondence Address: Siemens Corporation;Intellectual Property Department, 170 Wood Avenue South, Iselin, NJ, 08830, US

(21) Appl. No.: 10/501,101

(22) PCT Filed: Dec. 5, 2002
(86) PCT No.: PCT/DE02/04468

(30) Foreign Application Priority Data
Jan. 9, 2002 (DE) 102-53-782.8

(51) Int. Cl. H04Q 11/00

(52) U.S. Cl. 370/385

(57) ABSTRACT

The invention relates to a network node and to a method for adding a network node or an exchange in a communication network which may have the same signaling point code as another exchange in the communication network. Two internal local networks are established in an exchange of the telecommunication network and one signaling link is established from the second internal logical network to another exchange of the telecommunication network, via which all signaling of the other exchange is carried out. The invention is further characterized in that both exchanges use the same signaling point code.

### CROSS REFERENCE TO RELATED APPLICATIONS

This application is the US National Stage of International Application No. PCT/DE02/04468 filed Dec. 5, 2002 and claims the benefit thereof. The International Application claims the benefit of German application No. 10253782.8 filed Jan. 9, 2002, both of the applications are incorporated by reference herein in their entirety.

### FIELD OF INVENTION

The present invention relates to a network node or exchange and a method for adding exchanges in a communication network, said exchanges having the same signaling point code as other exchanges in the communication network.

### BACKGROUND OF INVENTION

Telecommunication networks consist of a multiplicity of exchanges (nodes), which can themselves form individual networks with the subscribers attached to them. In parallel with the actual user data, notifications or signaling for controlling the telecommunication networks are transmitted between the exchanges, wherein a distinction is essentially made between equipment at which signaling starts or terminates (signaling endpoint, SEP) and equipment which is used for connecting signaling endpoints (signaling transfer points, STP and signaling paths).

Every signaling point, e.g. an exchange (node), is uniquely identified in the network by a signaling point code (SPC). The exchanges forward incoming messages with reference to routing tables, which contain details of all possible destination signaling points and the signaling paths to be used. In this context, it is clear that a change in the signaling point code (SPC) of an exchange must be notified to all the relevant exchanges in the network.

If an existing exchange is replaced by a new exchange, it is advantageous if a substitution does not have to be sudden; i.e. it is advantageous for both exchanges to be operational during the transition phase. In this case, it is desirable to avoid adjustments in the other exchanges of the network for such a substitution if an additional exchange is only present during a transition phase.

### SUMMARY OF INVENTION

The invention addresses the problem of specifying an exchange and a method for adding exchanges in a communication network, which make it possible in relevant exchanges to avoid adjustments which become necessary as a result of an addition or removal of exchanges in the network.

This problem is solved according to the features in the independent patent claims. Thus two internal logical networks are set up in an exchange, and a signaling connection is created from the second internal logical network to another exchange of the telecommunication network, via which connection all signaling of the other exchange takes place. This makes it possible for both exchanges to have the same signaling point code, since only one exchange is visible from the network side. Consequently, adjustments in the network are no longer necessary when exchanges are added or removed. Subscribers and other connections (trunks) can be switched between the two exchanges without the need to change the signaling environment.

The method can be used on both an exchange which must be newly added and on an already existing (old) exchange. The second internal network is used exclusively for the connection of the original or the new exchange. The connection of the claimed exchange to the signaling network, on the other hand, takes place via the first internal network. The exchange which is coupled to the second internal network can communicate with the signaling network by means of a logical communication connection between the first and second internal network.

A signaling point code which is different from that of the exchange can be assigned to the second internal logical network, since this is only visible from the exchange which is coupled to the second internal logical network. If the method is applied to an exchange which must be newly added, a signaling point code which is already known to the other (old) exchange can be assigned to the second internal logical network. This reduces the costs in the old exchange.

Calls to “outside” which are received from the exchange which is coupled to the second internal logical network can be forwarded on the basis of the routing information of the first internal logical network. In this context, it is advantageous for Routeset-Test messages, which are sent from the exchange which is coupled to the second internal logical network, to be answered by the routing information from the first internal logical network.

In order to ensure that the message traffic of the exchange which is coupled to the second internal logical network can also be restricted in overload situations, overload messages which are received at the first internal logical network from the network are also sent to the exchange which is coupled to the second internal logical network. Since both exchanges are only visible as a single exchange in the network, Routeset-Congestion-Test messages which are sent by the exchange which is coupled to the second internal logical network, in response to the overload message, are blocked.

According to the invention, further internal logical networks which are similar to the first and second internal logical networks can be formed in pairs in the exchange, wherein each internal logical network can be assigned to a pair by means of a table or a mathematical algorithm.

In order to increase the signaling bandwidth between the old and new exchange, a third internal logical network is set up in addition to the second internal logical network, and a second signaling connection from the third internal logical network to the other exchange is established in the same way as in the case of the second internal logical network. Messages which are sent from the telecommunication network to the other exchange and arrive in the first internal logical network are allocated by means of a mathematical algorithm to the second internal logical network or the third internal logical network for forwarding.

The invention is developed by the features in the dependent claims.

### BRIEF DESCRIPTION OF THE DRAWINGS

The present invention is explained in greater detail with reference to the appended drawings, in which:

FIG. 1 shows a network section including the claimed exchange,

FIGS. 2a and 2b show procedures when receiving and sending messages in the claimed exchange as illustrated in FIG. 1,

FIGS. 3a and 3b show two exemplary applications of the claimed method,

FIG. 4 shows an example of the assignment of the connections in the claimed exchange,

FIG. 5 shows a further example of the assignment of the connections for increasing the signaling bandwidth in the claimed exchange, and

FIGS. 6a to 6d show an example of adding the claimed exchange.

### DETAILED DESCRIPTION OF INVENTION

The present invention is described with reference to Signaling System No. 7 (SS7), which defines modalities and information contents of the signaling between network nodes (exchanges) and is increasingly used in telecommunication networks.

The Message Transfer Part (MTP) forms the basis of the architecture of Signaling System No. 7. It creates a connection between two adjacent signaling points and ensures a failure-protected transfer of the control information between them. Various user parts are added to the Message Transfer Part, and create the virtual “end-to-end” connection between the originating exchange and the destination exchange.

In Signaling System No. 7, each signaling point is uniquely identified by signaling point code which is 14 bits (ITU-T) or 24 bits (ANSI) long. Every message contains the signaling point code of both the originating signaling point (Originating Point Code, OPC) and the destination signaling point (Destination Point Code, DPC). According to the ITU-T (International Telecommunication Union) and ANSI (American National Standards Institute) standard, it is not possible to operate two SS7 nodes (exchanges) having the identical signaling point code in one and the same MTP network.

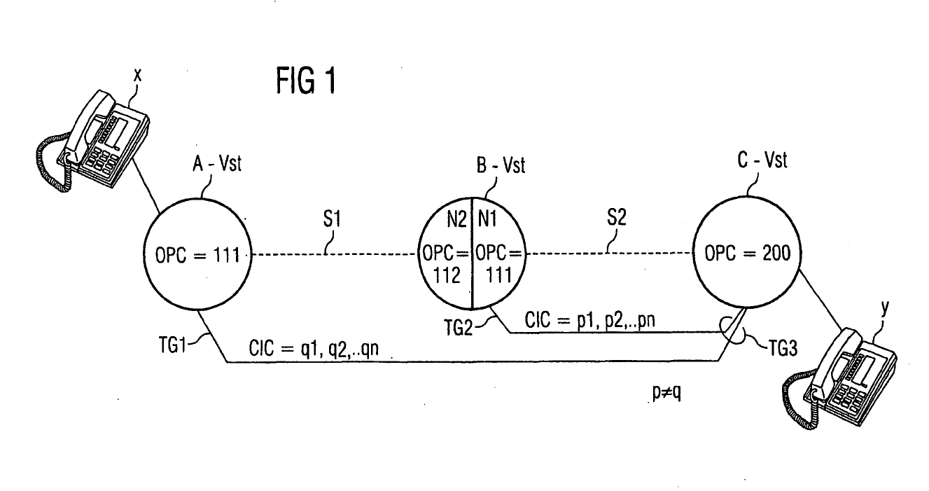

FIG. 1 shows an example in which two exchanges A-Vst, B-Vst having the identical signaling point code OPC=111 are operated in one and the same MTP network in accordance with the invention. According to the invention, the following applications are possible: either the exchange A-Vst can be the exchange which is to be newly added, in which case the already existing exchange B-Vst is adapted in accordance with the invention, or the exchange A-Vst already exists and the exchange B-Vst is added.

It is assumed that the already existing exchange A-Vst is to be replaced by the new exchange B-Vst, wherein it must be possible gradually to move onto the exchange B-Vst the connections of the exchange A-Vst to subscribers X and other exchanges (not shown).

To this end, two internal logical networks N1 and N2 are set up in the exchange B-Vst. All signaling paths of the exchange A-Vst to the nodes in the signaling network are initially assigned to the network N1. In addition, a signaling path S1 is set up between the exchange A-Vst and the network N2 of the exchange B-Vst, so that the exchange A-Vst has continued access to the signaling network.

Since an SS7 link can only be active between two different point codes, the signaling point code OPC=112 is assigned to the network N2. With the exception of the exchange A-Vst, this signaling point code OPC=112 is not visible to any of the other exchanges C-Vst in the SS7 network. It is therefore entirely possible that this signaling point code OPC=112 is assigned to another signaling node in the network.

When selecting a signaling point code OPC=112 for the internal network N2 in the exchange B-Vst, it is even advantageous to choose a signaling point code OPC=112 which is already used in the communication network and known to the exchange A-Vst, or to which there is already a signaling path, since the administration cost associated with the adjustment in the exchange A-Vst is reduced in this case.

The outgoing connections from the exchange A-Vst to subscribers X and exchanges (not shown) can now be migrated gradually onto the network N1 of the new exchange B-Vst by adapting the databases in the exchanges A-Vst and B-Vst, wherein a connection between the exchange A-Vst and a destination in the SS7 network is made via the exchange B-Vst.

The ISUP (ISDN User Part) signaled connection lines (trunks) TG1, TG2 which are coupled to the exchanges A-Vst and B-Vst differ within a trunk group by virtue of their voice circuit code CIC (Circuit Identification Code, CIC=q₁, q₂ . . . qₙ and CIC=p₁, p₂ . . . pₙ, where p≠q for all instances of p and q), and the individual subscribers differ by virtue of their directory number (DN).

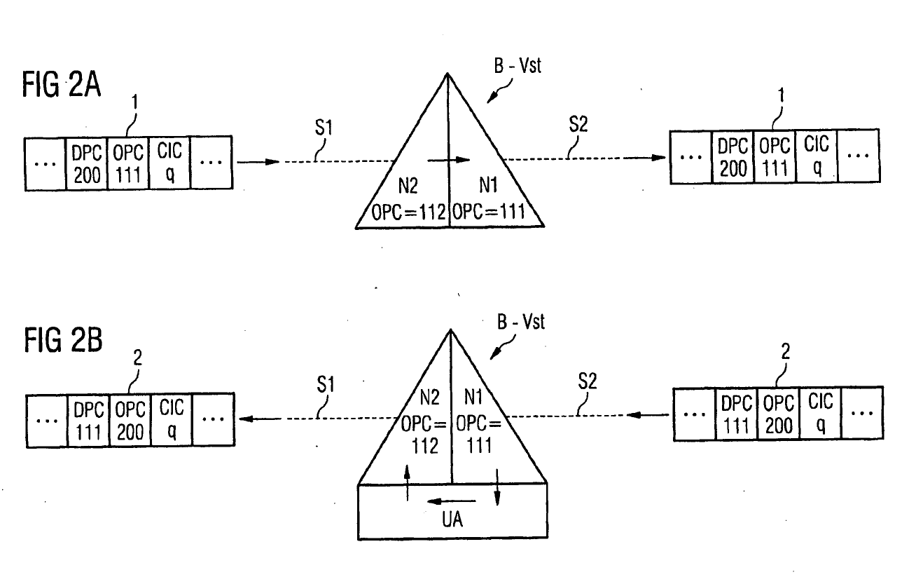

Because only the exchange A-Vst is connected to the network N2 of the exchange B-Vst, all messages arriving in the network N2 of the exchange B-Vst can be assigned to the exchange A-Vst. This is shown in FIG. 2a, using the example of a message 1 which is sent from the exchange A-Vst to the exchange C-Vst.

The message 1 contains the signaling point code of the source (originating signaling point) OPC=111 and that of the destination (destination signaling point) DPC=200. In the exchange B-Vst, the message 1 is forwarded to the exchange C-Vst by means of the MTP routing database of the network N1.

FIG. 2b shows the procedure in the opposite direction. All ISUP messages 2 which are received from the SS7 network and have the destination signaling point code OPC=111 initially arrive at the network N1 in the exchange B-Vst. From there, they are forwarded to the User Allocation UA function (MTP Layer 3) because they are specified for the local point code OPC=111. A check is performed here to determine whether the voice circuit code CIC=q is known or whether the corresponding trunk group has been set up. If this were the case, the message would be forwarded to the local ISUP user part (Layer 4).

In this example, because it was already partly moved from the exchange A-Vst to the network N1 of the exchange B-Vst, the corresponding trunk group is known at the exchange B-Vst. However, the trunks having the CIC values q (see FIG. 1) are not yet set up on the exchange B-Vst. The exchange B-Vst does not subsequently issue an error message (Unequipped Circuit Identification Code, UCIC), as would normally occur in such a case, but instead forwards the message 2 to the exchange A-Vst using the routing database of network 2. I.e. all the messages 2 arriving in the network N1 and addressed to the exchange B-Vst are simply forwarded to the network N2 if the messages 2 cannot be assigned.

During the transition phase, in order to reach subscribers on the exchange A-Vst for whom incoming ISUP calls from the exchange C-Vst nonetheless terminate on the exchange B-Vst, it is necessary to set up ISUP trunks between the exchanges A-Vst and B-Vst and to forward these incoming calls to the exchange A-Vst. This is known as “rerouting”. The ISUP trunks are also used as connection lines for calls between subscribers of the exchanges A-Vst and B-Vst. The signaling for this takes place via the internal network N2, i.e. these ISUP trunks are allocated to the local point code 112 in the exchange B-Vst.

SCCP (Signaling Connection Control Part) messages, which are sent from the SS7 network to the shared point code 111, are all forwarded to the corresponding SCCP applications on the exchange B-Vst, where a check is performed to determine whether they relate to a subscriber who is known on the exchange B-Vst. If this is not the case, the message is forwarded out of the network N2 from the application via SCCP and MTP directly to the exchange A-Vst (OPC=111).

In order to ensure a smooth operation:

Destinations which fail in the network N1 should also be reported to the exchange B-Vst (network N2) by means of TFP (Transfer Prohibited) messages.

RST (Routeset Test) messages from the exchange A-Vst which arrive in the network N2 should be answered using the routing information from network N1.

TFC (Transfer Controlled) messages which are sent from the SS7 network to the shared point code should be processed by both exchanges A-Vst, B-Vst. For this, TFC messages which arrive at exchange B-Vst in the network N1 are sent to the local User Part and via the network N2 to the exchange A-Vst, so that both exchanges A-Vst, B-Vst can react to the overload situation or restrict their traffic respectively. However, the subsequent Routeset Congestion Test in the direction of the SS7 network should only be performed by one of the exchanges A-Vst, B-Vst. Since both exchanges A-Vst, B-Vst start the test independently of each other, RSCT messages from the exchange A-Vst which arrive at the exchange B-Vst in the network N2 should be discarded.

The invention makes it possible to operate two exchanges A-Vst, B-Vst having the identical SS7 signaling point code in one and the same SS7 network. This is transparent to the remainder of the SS7 network, i.e. only one exchange B-Vst is visible. When introducing a new exchange B-Vst, it is no longer necessary for the various operators, e.g. in deregulated countries, to agree the time of introduction of the new exchange B-Vst. Adjustments or the linking of e.g. conventional circuit switching voice networks (Time Division Multiplex, TDM) to packet networks (IP) remain hidden from the competitor. The present invention is fully compatible with the SS7 standard. Administrative adaptations are only required in the exchanges A-Vst and B-Vst, but not in the remainder of the SS7 network.

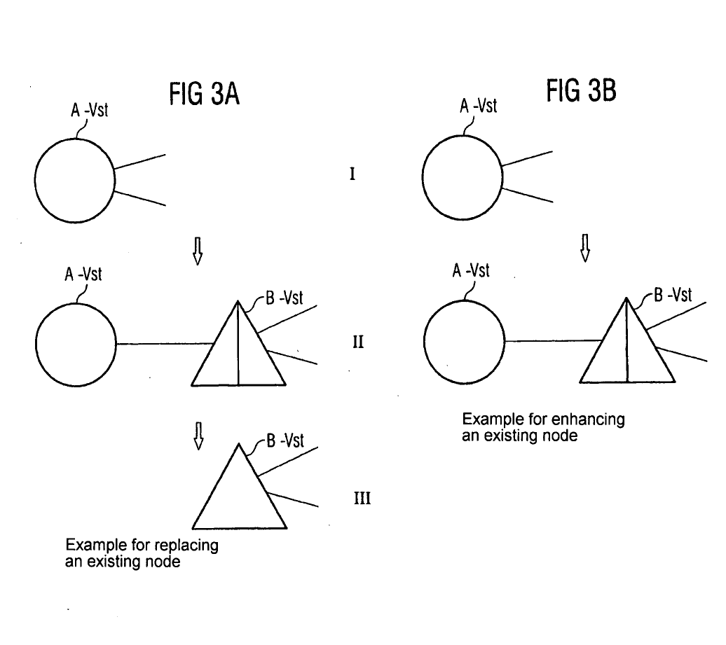

A new exchange B-Vst can first be tested with a part of the load before the complete changeover is effected. For cost reasons, it can also be advantageous to retain the old exchange A-Vst and the existing line cards when linking. These two application scenarios are illustrated in FIGS. 3a and 3b. Whereas following a transition phase II the old exchange A-Vst is replaced by the new exchange B-Vst in step III as shown in FIG. 3a, the new exchange B-Vst having new or enhanced features is added to the existing exchange A-Vst as shown in FIG. 3b.

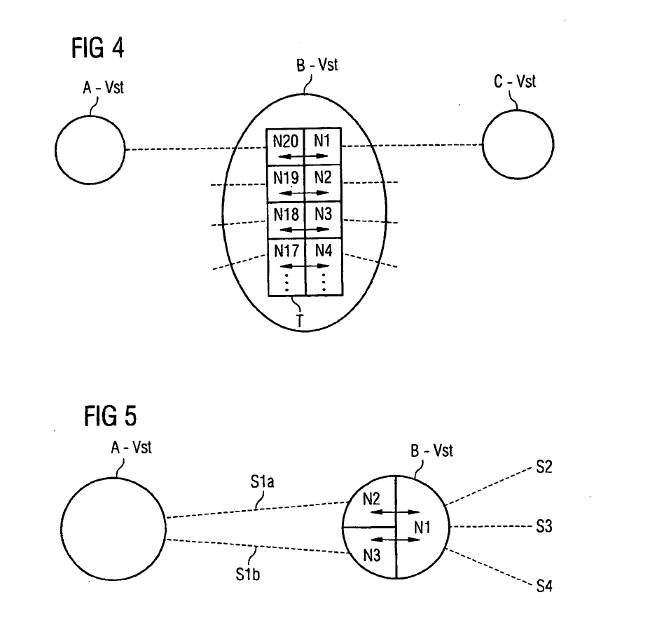

FIG. 4 shows a further exemplary embodiment of the claimed exchange B-Vst in a network section. Twenty internal logical networks N1 . . . N20 are set up in the exchange B-Vst, wherein the networks N1 . . . N20 are assigned to each other in pairs N1-N20, N2-N19, etc. This assignment can be represented in the exchange B-Vst in the form of a table T, for example. The operations when transmitting data in each network pair N1-N20, N2-Nl9, etc. are analogous to those described in FIGS. 1 and 2. I.e. the messages from an exchange (not shown) which arrive in the network N3 are forwarded to the network N18 by means of the table T, without an error message, if the addresses of the messages are not known to the network N2. The message is sent from the network N18 to the exchange (not shown) which is coupled to the network N18. In the opposite direction, messages arriving in the network N18 are forwarded to the network N3 by means of the table T.

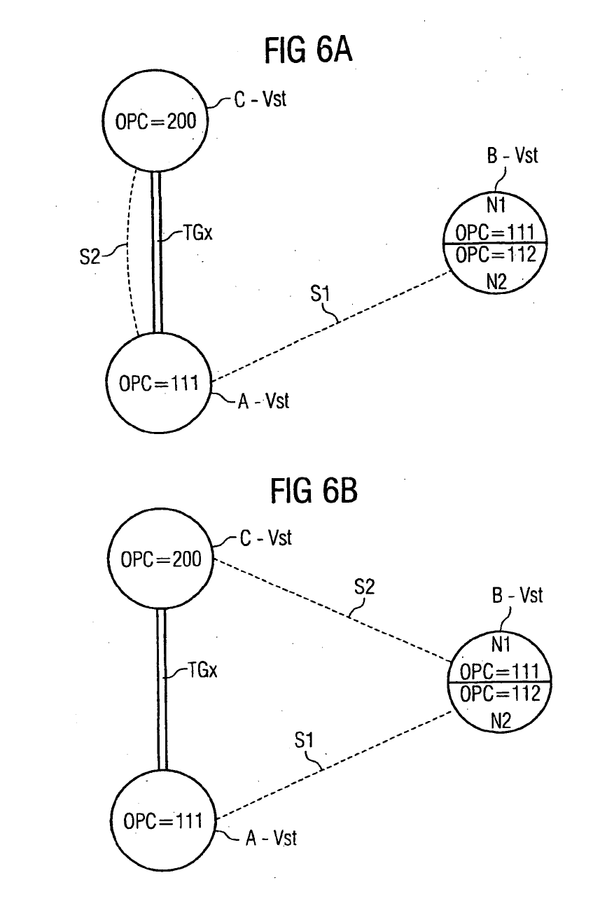

In the example shown in FIG. 5, an assignment between the network N1 and the network N2 or N3 takes place in the exchange B-Vst by means of a mathematical algorithm. The messages arriving in the network N1 from the signaling connections S2 . . . S3 and relating to the exchange A-Vst are forwarded to the network N2 or N3 by means of a mathematical algorithm. From the network N2 and N3, the messages reach the exchange A-Vst via the signaling connection S1a or S1b. The signaling bandwidth between the exchanges A-Vst and B-Vst can be increased in this context.

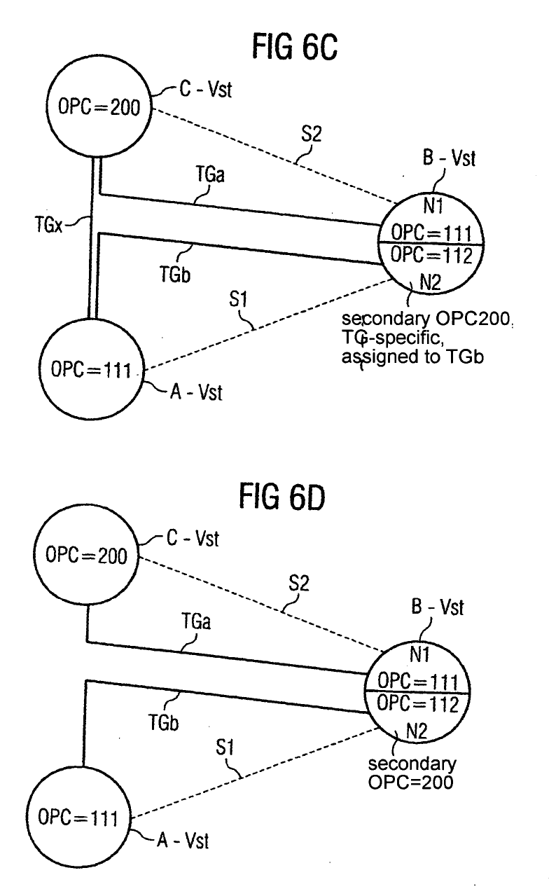

FIGS. 6a to 6b show an example of the procedure when adding a new exchange B-Vst according to the invention. The exchange B-Vst contains new features and is to be added to the exchange A-Vst. The networks N1 and N2 are set up in the new exchange B-Vst. The signaling connection S2 and the trunk group TGx exist between the exchanges C-Vst and A-Vst. Firstly, a signaling connection S1 is set up between the new exchange B-Vst and the exchange A-Vst (FIG. 6a), and the signaling connection S2 between the exchanges C-Vst and A-Vst is switched from the exchange A-Vst to the new exchange B-Vst (FIG. 6b). A part TGa, TGb of the trunk group TGx (unused or blocked trunks) between the exchanges C-Vst and A-Vst is then rerouted to the new exchange B-Vst (FIG. 6c). Following the successful rerouting or establishment of the alternative connection, the remaining trunks TGx between the exchanges C-Vst and A-Vst are discontinued. All the messages which are sent to the signaling point code OPC=111 are forwarded by the new exchange B-Vst (FIG. 6d).

The claimed method can also be used on already existing exchanges A-Vst. For this, e.g. two internal networks N1, N2 are set up in the exchange, wherein all existing connections and subscribers are assigned to one network N1 and the coupling of a new exchange A-Vst is done by means of the other network N2. In the same way, connections and subscribers can then be moved from the network N1 of the existing exchange B-Vst to the new exchange A-Vst.

The term exchange generally signifies any signaling network node SNK (STP, SRP, SEP) in a telecommunication network. In particular, networks are also included in which SS7 signaling is not used on trunks (e.g. ISUP).

1-20. (canceled)

21. A network node in a telecommunication network, wherein
at least two internal logical networks are set up in the network node, wherein
a signaling connection is set up from the second internal logical network to a network node of the telecommunication network, via which signaling connection all signaling of the other network node is done, and wherein
both network nodes have the same signaling point code.

22. The network node as claimed in claim 21, wherein the second internal logical network comprises a signaling point code which is distinct from the network node.

23. The network node as claimed in claim 21, wherein signaling connections are set up from the first internal logical network to other network nodes of the telecommunication network, and signaling relating to the network node which is coupled to the second internal logical network takes place via said signaling connections.

24. The network node as claimed in claim 21, wherein messages are sent to the network node which is coupled to the second internal logical network, said messages showing that a destination in the first logical internal network has failed.

25. The network node as claimed in claim 21, wherein Routeset Test messages which are sent from the network node which is coupled to the second internal logical network are answered with the routing information from the first internal logical network.

26. The network node as claimed in claim 21, wherein overload messages arriving at the first internal logical network from the telecommunication network are sent to the network node which is coupled to the second internal logical network.

27. The network node as claimed in claim 26, wherein overload test messages which are sent from the network node which is coupled to the second internal logical network (N2) in response to the overload message are blocked.

28. The network node as claimed in claim 21, wherein the first and second internal logical networks form a first pair from internal logical networks, and further pairs of internal logical networks are set up in the same way as the first pair.

29. The network node as claimed in claim 28, wherein each of the internal logical networks is assigned to a pair by a table or a mathematical algorithm.

30. The network node as claimed in claim 21, wherein
at least a third internal logical network is set up in addition to the second internal logical network, wherein
a second signaling connection exists from said third internal logical network to the other network node in the same way as from the second internal logical network, and wherein
messages from the telecommunication network which are sent to the other network node and arrive in the first internal logical network and/or messages which are sent out of the first internal network to the other network node are assigned by a mathematical algorithm to the second internal logical network or the third internal logical network for forwarding.

31. A method for adding network nodes in a telecommunication network, comprising:
setting up two internal logical networks in a network node of the telecommunication network; and
setting up a signaling connection from the second internal logical network to another network node of the telecommunication network, wherein
via the signaling connection all signaling of the other network node is done, and wherein
both network nodes have the same signaling point code.

32. The method as claimed in claim 31, wherein
the network node in which the two internal logical networks are set up is the network node which is to be added, and wherein
a signaling point code which is already known by the other network node is assigned to the second internal logical network.

33. The method as claimed in claim 31, further comprising:
setting up signaling connections from the first internal logical network to other network nodes of the telecommunication network, wherein signaling relating to the network node which is coupled to the second internal logical network takes place via said signaling connections.

34. The method as claimed in claim 31, further comprising:
sending messages to the network node which is coupled to the second internal logical network, said messages indicating that a destination in the first internal logical network has failed.

35. The method as claimed in claim 31, wherein Routeset Test messages which are sent from the network node which is coupled to the second internal logical network are answered with the routing information from the first internal logical network.

36. The method as claimed in claim 31, further comprising:
sending overload messages arriving at the first internal logical network from the telecommunication network to the network node which is coupled to the second internal logical network.

37. The method as claimed in claim 36, wherein overload test messages which are sent from the network node which is coupled to the second internal logical network in response to the overload message are blocked.

38. The method as claimed in claim 31, wherein the first and second internal logical networks form a first pair from internal logical networks, and wherein further pairs of internal logical networks are set up in the same way as the first pair.

39. The method as claimed in claim 38, wherein each of the internal logical networks is assigned to a pair by a table or a mathematical algorithm.

40. The method as claimed in claim 31, further comprising:
setting up at least a third internal logical network in addition to the second internal logical network, wherein
a second signaling connection exists from the third internal logical network to the other network node in the same way as from the second internal logical network, wherein
messages from the telecommunication network which are sent to the other network node and arrive in the first internal logical network and/or messages which are sent out of the first internal network to the other network node are assigned by a mathematical algorithm to the second internal logical network or the third internal logical network for forwarding.
